(19) United States
(12) Patent Application Publication
(10) Pub. No.: US 2003/0095794 A1
(43) Pub. Date: May 22, 2003

(54) Information storage medium containing event occurrence information, and method and apparatus therefor

(75) Inventors: Hyun-Kwon Chung, Gyeonggi-do (KR); Seong-Jin Moon, Gyeonggi-do (KR); Jung-kwon Heo, Seoul (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-City (KR)

(21) Appl. No.: 10/278,094

(22) Filed: Oct. 23, 2002

(30) Foreign Application Priority Data
Oct. 23, 2001 (KR) 2001-65390
Dec. 3, 2001 (KR) 2001-75901
Mar. 16, 2002 (KR) 2002-14273
Oct. 15, 2002 (KR) 2002-62691

(51) Int. Cl. H04N 5/781

(52) U.S. Cl. 386/95; 386/125

(57) ABSTRACT

An information storage medium and a method of and an apparatus for playing the information storage medium include AV data, which includes a video title set containing at least one video object that is constituted of video object units each having an audio pack, a video pack, and a navigation pack, and event occurrence information for generating an event designated based on a data structure of the AV data. Accordingly, a markup document screen can be more easily output in synchronization with an AV screen by utilizing the data structure of an existing DVD-Video without change.

### CROSS-REFERENCE TO RELATED APPLICATIONS

This application claims the benefit of Korean Patent Application Nos. 2001-65390, 2001-75901, 2002-14273, and 2002-62691, filed Oct. 23, 2001, Dec. 3, 2001, Mar. 16, 2002, and Oct. 15, 2002, respectively, in the Korean Intellectual Property Office, the disclosure of which is incorporated herein by reference.

### BACKGROUND OF THE INVENTION

1. Field of the Invention

The present invention relates to a field of interactive digital versatile discs (DVDs), and more particularly, to an information storage medium and a method of and an apparatus for playing the information storage medium, by which a web document can be reproduced without changing a format of a DVD-Video.

2. Description of the Related Art

A digital versatile disc (DVD) containing a web document together with AV data based on a personal computer (PC), which is hereinafter referred to as an interactive DVD, is sold in a current market. The AV data recorded on the interactive DVD can be reproduced in two modes: a video mode in which the reproduced AV data is displayed in the same way as general DVDs, and an interactive mode in which the reproduced AV data is displayed through a display window defined by a web document. If a user adopts (selects) the interactive mode, a web browser of the PC displays the web document recorded on the interactive DVD. The display window of the web document displays the AV data selected by the user. If the selected AV data is a movie, the display window of the web document displays the movie, while an area other than the display window displays a variety of additional information, such as a movie script, a synopsis, pictures of actors and actresses, or the like. The additional information includes an image file or a text file.

However, in the interactive mode, in order to display the AV data through the display window defined according to an HTML language, the AV data needs to be synchronized with the web document. The synchronization generally needs to be precise, so that the AV data and the web document are simultaneously reproduced at a set time and displayed together. However, the synchronization can be rough even though a relationship between the AV data and the web document is maintained. In a conventional interactive mode, the synchronization might be achieved by using a timer implemented as a software system. However, it may be complicated to implement the synchronization that is dependent on the timer. This complication becomes more serious when a plurality of events occur at the same time.

### SUMMARY OF THE INVENTION

To solve the above and other problems, it is an aspect of the present invention to provide an information storage medium and a method of and an apparatus for playing the information storage medium, by which AV data and a markup document are more simply reproduced in synchronization.

Another aspect of the present invention is to provide an information storage medium and a method of and an apparatus for playing the information storage medium, by which AV data and a markup document are synchronously reproduced using an existing DVD-Video format.

Still another aspect of the present invention is to provide an information storage medium and a method of and an apparatus for playing the information storage medium, by which a point in time when an event occurs is more simply designated and a particular event occurs at the designated point in time.

Additional objects and advantageous of the invention will be set forth in part in the description which follows and, in part, will be obvious from the description, or may be learned by practice of the invention.

The above and other aspects are achieved by providing an information storage medium including AV data, which includes at least one video object that is constituted of video object units each having an audio pack, a video pack, and a navigation pack, and event occurrence information for generating an event designated based on a data structure of the AV data.

It is possible that the information storage medium further includes a markup document for outputting an AV screen from the AV data, and the event occurrence information is recorded in the markup document.

The AV data is recorded as a video title set constituted of at least one video object. It is possible that the event occurrence information is for requesting that a trigger event occurs when a video object unit corresponding to the navigation pack of a designated video title set is reproduced. That is, the event occurrence information is for requesting that designated contents are output on a screen when the video object unit corresponding to the navigation pack of the designated video title set is reproduced.

The above and other aspects of the present invention are achieved by a method of playing an information storage medium comprising AV data, which includes at least one video object that is constituted of video object units, each video object unit having an audio pack, a video pack, and a navigation pack, and event occurrence information for generating a predetermined event. In the method, first, the event occurrence information is interpreted. Then, if a data structure matched with an interpretation result is discovered while the AV data is being decoded, the event is generated.

It is possible that in the interpretation operation of the method, first, the event occurrence information in a markup document defining a display window for displaying an AV screen on which the video object is reproduced, is interpreted. A place in which the event matched with the interpretation result occurs is then detected.

It is also possible that a video title includes at least one video object that is constituted of cells each having the audio pack, the video pack, and the navigation pack, and that the event occurs when a portion of the AV data corresponding to the place of the event is reproduced.

The above and other aspects are achieved by providing an apparatus for playing an information storage medium comprising AV data, which includes at least one video object that is constituted of video object units each having an audio pack, a video pack, and a navigation pack, and event occurrence information for generating a predetermined event. In the apparatus, a reader reads the AV data or the event occurrence information. A presentation engine interprets the read event occurrence information, outputs an interpretation result, and generates an event. A decoder requests the presentation engine to generate an appropriate event if a data structure matched with the interpretation result received from the presentation engine is discovered while the AV data is being decoded.

### BRIEF DESCRIPTION OF THE DRAWINGS

The above and other aspects and advantages of the present invention will become more apparent and more readily appreciated by describing in detail preferred embodiments thereof with reference to the attached drawings in which:

FIG. 1 is a directory structure diagram of an information storage medium according to an embodiment of the present invention;

FIGS. 2A and 2B are data structure diagrams of reproduction control information of a DVD video directory VIDEO_TS of the directory structure shown in FIG. 1;

FIG. 3 is a detailed structure diagram of a video title set (VTS) of the reproduction control information shown in FIG. 2A;

FIG. 4 is a detailed structure diagram of a navigation pack NV_PCK shown in FIG. 3;

FIGS. 5 and 6 are detailed structural diagrams of a presentation control information (PCI) packet shown in FIG. 4;

FIGS. 7A, 7B, and 8 are reference diagrams illustrating a program chain (PGC);

FIG. 9A is an image produced when NV_PCK_LBN is 0 in the presentation control information packet shown in FIG. 6;

FIG. 9B is an image produced when NV_PCK_LBN is 1000 in the presentation control information packet shown in FIG. 6;

FIG. 10 is a block diagram of a reproduction apparatus according to another embodiment of the present invention;

FIG. 11 is a block diagram of a decoder of the reproduction apparatus shown in FIG. 11;

FIG. 12 is a detailed reference diagram for illustrating a process of generating an event in the reproduction apparatuses shown in FIGS. 10 and 11;

FIG. 13 is a flowchart illustrating a reproduction method according to another embodiment of the present invention;

FIG. 14 is a flowchart illustrating another reproduction method according to another embodiment of the present invention; and

FIG. 15 is a flowchart illustrating another reproduction method according to another embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

An information storage medium according to an embodiment of the present invention stores a video title set containing a video object (VOB). The video object (VOB) includes video object units (VOBUs) each including an audio pack, a video pack, and a navigation pack. The information storage medium stores a markup document supporting an interactive mode. In the present specification, the markup document denotes a markup resource including not only a markup document itself but also various image and graphic files contained in the markup document. A markup document screen indicates a screen on which the markup document interpreted by a markup document viewer is displayed. The markup document defines a display window for outputting decoded AV data, that is, decoded video object units. The markup document also defines event occurrence information used to generate a trigger event in a method of reproducing data from the information storage medium according to the present invention.

The event occurrence information is defined based on a data structure of AV data recorded in the information storage medium without changing the data structure. To be more specific, if a specified navigation pack of a specified video title set is discovered and a video object set having the navigation pack is reproduced, a corresponding trigger event is required to occur. Accordingly, when the video object set starts being reproduced, a specified content is displayed on a predetermined area of the markup document screen. The event occurrence information according to the present invention will be described in greater detail later.

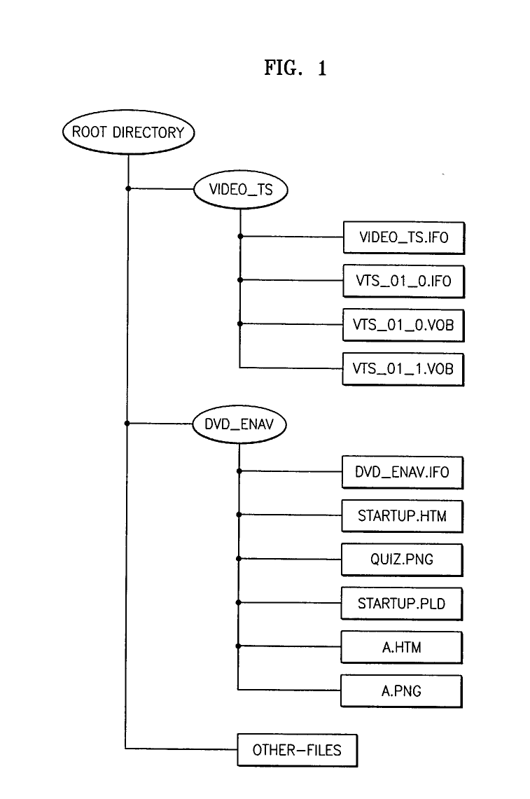

FIG. 1 is a directory structure diagram of the information storage medium according to an embodiment of the present invention. Referring to FIG. 1, a root directory includes a DVD video directory VIDEO_TS in which AV data is contained. The DVD video directory VIDEO_TS includes a file VIDEO_TS.IFO that contains navigation information regarding an entire video title recorded in the information storage medium. In the file VIDEO_TS.IFO, language information designated as a default value for a video title set is recorded. The DVD video directory VIDEO_TS also includes a file VTS_01_0.IFO in which navigation information on each video title set is recorded. In addition, video titles VTS_01_0.VOB, VTS_01_1.VOB, . . . , which constitute a total video title set, are recorded in the VIDEO_TS. The video titles VTS_01_0.VOB, VTS_01_1.VOB, . . . are referred to as VOBs. Each of the VOBs has an integer number of VOBUs each generally having a navigation pack, at least one video pack, and an audio pack. A detailed structure of a VOBU is disclosed in a DVD-Video standard, e.g., DVD-Video for Read Only Memory disc 1.0 published by the DVD consortium.

The root directory also includes a directory DVD_ENAV in which a navigation file DVD_ENAV.IFO is recorded. For example, the navigation file DVD_ENAV.IFO includes a definition of a corresponding directory, a structure of the pertinent directory, the number of titles included in the corresponding directory, basic information regarding the corresponding directory, a language used in the titles, information on a subtitle and font, markup document display information, such as a resolution and a color, and copyright information. The directory DVD_ENAV also includes STARTUP.HTM, which is a markup document that defines a display window for displaying an AV image. STARTUP.HTM includes event occurrence information for generating a trigger event in a method according to the present invention. The event occurrence information included in STARTUP.HTM is implemented by an application program interface (API). The API has, as parameters, a trigger event identifier, a video identifier for a specified video title set, and a navigation identifier for a specified navigation pack.

The directory DVD_ENAV can also include a pre-loading list file STARTUP.PLD for performing pre-loading depending on pre-loading information recorded in STARTUP.HTM. QUIZ.PNG is an example of a file that contains a content which is output in synchronization with an AV screen when the trigger event based on the file STARTUP.HTM occurs. A.HTM is a file to be pre-loaded, and A.PNG is a file linked to the file A.HTM. The applicants of the present invention filed Korean Application No. 2001-65393 entitled “Information Storage Medium Containing Pre-loading Information and Apparatus and Method of Playing the Information Storage Medium.” Since the above-mentioned application describes in detail the pre-loading information, that is, a pre-loading list file, a to-be-preloaded file, and the API for preloading, only the necessary contents will now be briefly described.

The pre-loading information commands that the to-be-preloaded file are read out and stored in a cache memory. For example, the pre-loading information can be implemented as a link tag, which includes the path and/or attributes of the pre-loading list file. The link tag is bounded with a pair of head tags. Alternatively, the pre-loading information can be implemented as the API that includes, as the parameters, a path and/or attributes of the pre-loading list file and calls the pre-loading list file. A resource locator can be attached to the path for the pre-loading list file and the to-be-preloaded file. Hence, the path used to call the to-be-pre- loaded file A.HTM recorded on a DVD is dvd://DVD_ENAV/A.HTM.

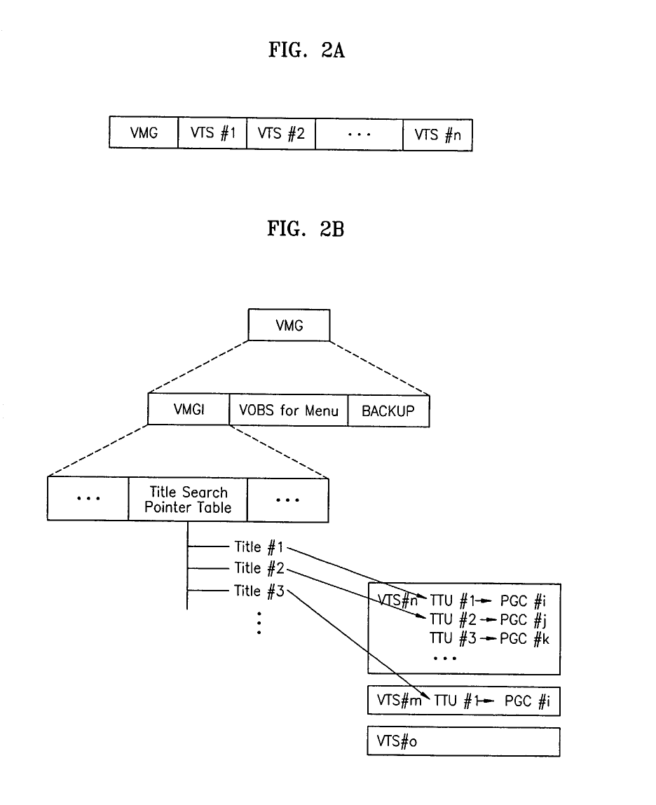

FIGS. 2A and 2B are data structure diagrams of reproduction control information of the DVD video of FIG. 1. Referring to FIG. 2A, the DVD video directory VIDEO_TS stores n video title sets VTS #1, VTS #2, . . . , and VTS #n and a video manager (VMG) in which introduction information regarding all of the video titles VOBs is recorded. Referring to FIG. 2B, a VMG includes video manager information (VMGI), which contains control data, the video object set (VOBS) linked to the VMG, and backup data of the VMGI. The VOBS may not be included in the VMG.

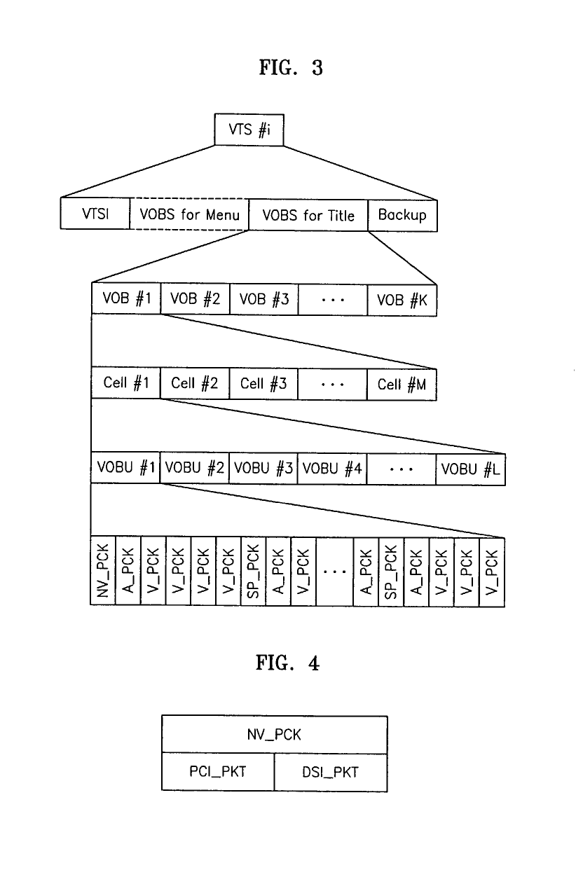

FIG. 3 is a detailed structure diagram of the video title set (VTS) of FIG. 2A. Referring to FIG. 3, each video title set VTS #i includes video title set information (VTSI) containing header information, a VOBS for menu for displaying a menu screen, a VOBS for title for constituting a video title set, and VTSI backup data. The VOBS for menu for displaying the menu screen may not be included in the video title set VTS #i.

The VOBS for title for constituting the video title set includes K video objects VOB #1, VOB #2, . . . , and VOB #K. A VOB includes M cells Cell #1, Cell #2, . . . , and Cell #M. Each cell includes L VOBUs #1, #2, . . . , and #L. A VOBU includes a navigation pack NV_PCK necessary for reproducing or searching for the corresponding VOBU. Also, audio packs A_PCK, video packs V_PCK, and sub-picture packs SP_PCK are multiplexed and recorded in the VOBU.

FIG. 4 is a detailed structure diagram of the navigation pack NV_PCK. Referring to FIG. 4, the navigation pack NV_PCK is constituted of a presentation control information (PCI) packet PCI_PKT and a data search information (DSI) packet DSI_PKT. The PCI packet includes PCI necessary for reproducing the video pack and/or the audio pack. The DSI packet includes DSI necessary for searching the video pack and/or the audio pack.

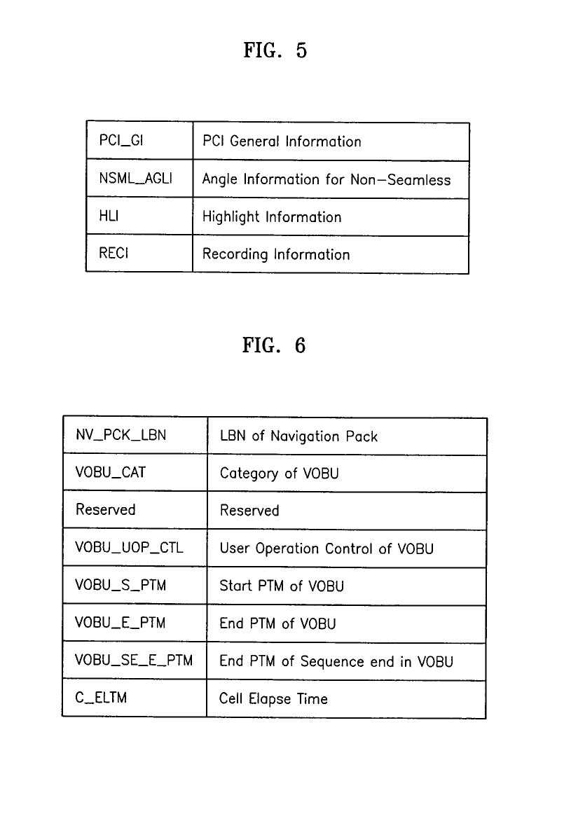

FIGS. 5 and 6 are detailed structural diagrams of the PCI packet of FIG. 4. Referring to FIG. 5, the PCI packet includes a PCI_GI, which contains header information, an NSML_AGLI, which contains angle information for non-seamless reproduction, an HLI, which contains highlight information, and an RECI, which contains recording information.

Referring to FIG. 6, the PCI_GI includes a logical block number (LBN) of the navigation pack, NV_PCK_LBN, a category of the VOBU VOBU_CAT, a user operation control of the VOBU VOBU_UOP_CTL, a starting point in time of the VOBU VOBU_S_PTM, an ending point in time of the VOBU VOBU-E_PTM, the ending point in time of a sequence end in the VOBU VOBU_SE_E_PTM, and a cell elapse time C_ELTM. NV_PCK_LBN denotes the number of the navigation pack. VOBU_CAT denotes a status of an analog protection system (APS). VOBU_UOP_CTL denotes a user operation prohibited when the VOBU is reproduced and displayed. VOBU_S_PTM denotes a point in time for starting reproduction of video data included in the VOBU. VOBU_E_PTM denotes a point in time for ending reproduction of the video data included in the VOBU. VOBU_SE_E_PTM is a code that indicates a termination of the reproduction of the video data included in the VOBU. C_ELTM describes a time that elapses from a starting time for reproducing a first VOBU to another starting time for reproducing the corresponding VOBU within a corresponding cell.

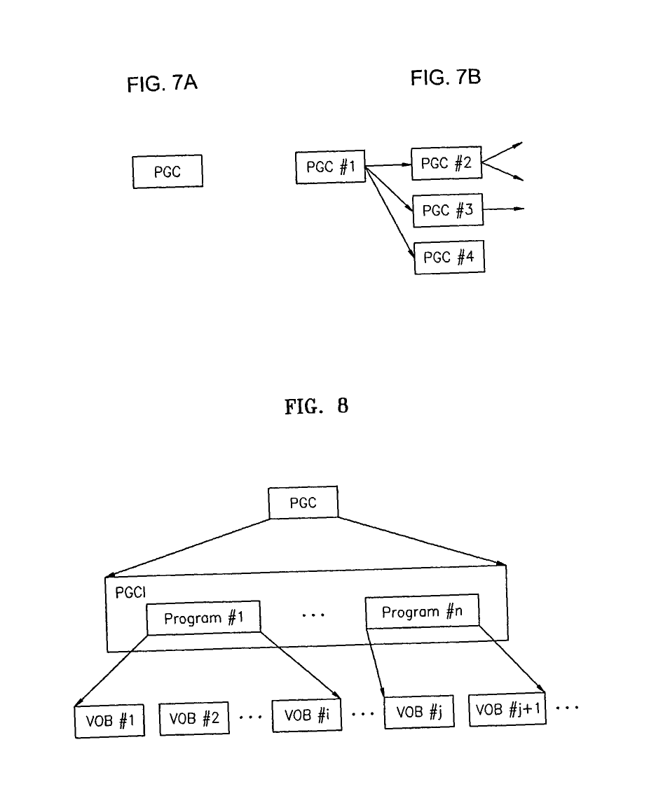

FIGS. 7A, 7B, and 8 are reference diagrams illustrating a program chain (PGC). The PGC denotes a reproduction sequence of a logic unit, that is, a program, for reproducing a whole or part of the video title. In other words, the video title is constituted of at least one PGC. Referring FIG. 7A, the PGC represents that the video title includes only one PGC, and in FIG. 7B, PGC #1 represents that the video title is defined with a plurality of PGCs. Referring to FIG. 8, the PGC is linked to the cells of a corresponding VOB via program chain information (PGCI). The PGCI is defined in the VMGI of FIG. 2B and the VTSI of FIG. 3. The PGCI contains a program chain number (PGCN). The PGCN is a serial number allocated to the PGC and serves as an identifier of the PGC.

In an aspect of the present invention, NV_PCK_LBN and VOBU_S_PTM are used as the parameters to generate the trigger event, as described later. In another aspect of the present invention, the number of program chains PGCNs and the elapsed time C_ELTM of reproducing the program chain PGCN are used as the parameters to generate the trigger event. In still another aspect of the present invention, a title number (TTN) included in a VMG and the elapsed time of reproducing the video title are used as the parameters to generate the trigger event.

For the trigger event, APIs and necessary parameters are included in the markup document STARTUP.HTM. These will now be enumerated in detail.

1. DvdVideo.SetTrigger (trigger_id, vtsn, nv_lbn, ref)

This API indicates that the trigger event occurs when the VOBU containing the specified navigation pack NV_PCK in the specified video title set VTS starts being reproduced.

A first parameter, trigger_id, denotes an identifier of the trigger event. A second parameter, vtsn, denotes the number of the video title set VTS for which the trigger event is to occur. A third parameter, nv_lbn, denotes the number of the navigation pack NV_PCK_LBN, the navigation pack NV_PCK existing within the video title set VTS for which the trigger event is to occur. A fourth parameter, ref, denotes a value to be contained in the second parameter when a specific event is called.

For example, DvdVideo.SetTrigger (0,1,1000,0); // indicates that the trigger event occurs at the point in time VOBU_S_PTM when the VOBU having the navigation pack NV_PCK corresponding to vtsn=1 and nv_lbn=1000 starts being reproduced. The trigger event does not need to perfectly synchronize with the AV screen. The trigger event may occur within several tens of msec (e.g., about 50 msec) after the reproduction starting point in time.

2. DvdVideo.SetTrigger (trigger_id, vob_id, vobu_s_ptm, ref)

This API indicates that the trigger event occurs at the start of reproduction of the VOBU containing the specified navigation pack NV_PCK in the video title set VTS to which the movie title being currently reproduced belongs.

The first parameter, trigger_id, denotes the identifier of the trigger event. A second parameter, vob_id, denotes the identifier of the VOB within the video title set VTS for which the trigger event is to occur. A third parameter, vobu_s_ptm, denotes the number of the navigation pack NV_PCK_LBN which exists within the video title set VTS for which the trigger event is to occur. The fourth parameter, ref, denotes the value to be contained in the second parameter when the event is called.

For example, DvdVideo.SetTrigger (0,1,180000,0); // instructs that the trigger event occurs at the point in time VOBU_S_PTM when the VOBU having the navigation pack NV_PCK corresponding to vtsn=1 and vobu_s_ptm=180000 starts being reproduced. The trigger event does not need to perfectly synchronize with the AV screen. The trigger event may occur within several seconds after the point in time VOBU_S_PTM when reproduction starts. Since the vobu_s_ptm is a value that is processed in units of 1/90000 sec, the parameter vobu_s_ptm is expressed in hour:minute:second:millisecond (hh:mm:ss:ms) for convenience of a manufacturer of the information storage medium and can also be processed in units of 1/90000 second into which the unit hh:mm:ss:ms is converted.

3. DvdVideo.SetTrigger (trigger_id, ttn, elapsed_time, ref)

This API instructs that the trigger event occurs at the start of reproduction of the VOBU containing the navigation pack NV_PCK at the specified elapsed time C_ELTM at the specified video title number.

The first parameter, trigger_id, denotes the identifier of the trigger event. The second parameter, ttn, denotes the number of the video title set VTS for which the trigger event is to occur. The third parameter, elapsed_time, denotes a reproduction elapsed time within the video title set VTS for which the trigger event is to occur. The fourth parameter, ref, denotes the value to be contained in the second parameter when the event is called.

For example, DvdVideo.SetTrigger (0,1, “00:20:10”, 0); // instructs that the trigger event occurs when starting reproduction of the VOBU having the navigation pack NV_PCK corresponding to ttn=1 and elapsed_time=20 minutes:10 seconds during the video title reproduction. The trigger event does not need to perfectly synchronize with the AV screen. The trigger event may occur within several tens of msec (e.g., about 50 msec) after the point in time when reproduction starts.

4. DvdVideo.ClearTrigger (trigger_id)

This API denotes cancellation of a requested trigger event.

The parameter trigger_id denotes the identifier of the trigger event. By designating −1 to the parameter trigger_id, the parameter trigger_id can also be used to denote cancellation of all occurred trigger events.

For example, DvdVideo.ClearTrigger( −1); // instructs that all trigger events are cancelled.

5. DvdVideo.VTSNumber

This API denotes that the number of the video title set VTS to which the VOBU currently being reproduced belongs is to be provided.

For example, var a=DvdVideo.VTSNumber // instructs that the number of the video title set VTS currently being reproduced is stored in variable a.

6. DvdVideo.CurrentPosition

This API represents that the number of the navigation pack present NV_PCK_LBN within the video title set VTS to which the VOBU currently being reproduced belongs is to be provided.

For example, var b=DvdVideo.CurrentPosition // instructs that the number of the navigation pack NV_PCK_LBN within the video title set VTS currently being reproduced is stored in variable b.

7. DvdVideo.VOB_ID

This API denotes the identifier of the VOB, VOB_ID, to which the VOBU currently being reproduced belongs.

For example, var a=DvdVideo.VOB_ID // instructs that the VOB_ID is stored in variable a.

8. DvdVideo.CurrentTime

This API denotes provision of the VOB_S_PTM of the navigation pack NV_PCK to which the VOBU currently being reproduced belongs. This time can be expressed in hh:mm:ss:ms (hour:minute:second:millisecond) so that the manufacturer can easily use the time.

For example, var b=DvdVideo.CurrentTime // indicates that the VOB_S_PTM of the VOBU currently being reproduced is stored in variable b.

Meanwhile, APIs for preloading included in a source code will now be enumerated.

1. navigator.Preload (URL,flag)

This is an API that preloads to-be-preloaded files into a cache memory. Parameters used for this API represent information regarding positions of the preloading list file and the to-be-preloaded file.

The parameter, URL, denotes the path of the preloading list file or the to-be-preloaded file. The parameter, flag, is 1 for the preloading list file or 0 for the to-be-preloaded file. A “true” is returned as a return value if preloading succeeds, or a “false” is returned as the return value if preloading fails.

For example, navigator.Preload (“http://www.hollywood.com/tom.pld”,1) // instructs that indicated to-be-preloaded files are preloaded into the cache memory by searching the preloading list file at the Internet address “http://www.hollywood.com/tom.pld.”

2. navigator.Preload (URL,resType)

This is an API that preloads the to-be-preloaded files into the cache memory.

Parameters used for this API can represent information regarding the positions of the preloading list file and the to-be-preloaded file and, furthermore, the attributes of the to-be-preloaded file. The parameter, URL, denotes the path of the preloading list file or the to-be-preloaded file. The parameter, resType, denotes the attributes of the to-be-preloaded file. The “true” is returned as the return value if preloading succeeds, or the “false” is returned as the return value if preloading fails.

For example, navigator.Preload (“dvd:dvd_enav/a.htm”, “text/xml”) // indicates to read out the to-be-preloaded file of “dvd://dvd_enav/a.htm” existing on a dvd. The to-be-preloaded file is an xml text file.

An API, navigator.Preload (“http://www.hollywood.com/tom.htm”, “text/html”) //, indicates to read out a file of “http://www.hollywood.com/tom.html” existing on the Internet. The file is an html text file.

An example of a DvdVideoEvent Object structure is as follows.

Interface DvdEvent : Event {

readonly attribute unsigned longindex; // id of Event
readonly attribute unsigned long parm1;
readonly attribute unsigned long parm2;
readonly attribute unsigned long parm3;
void initDVDEvent (in DOMString typeArg,
in boolean canBubbleArg,
in boolean cancelableArg,

in unsigned long indexArg,
in unsigned long parm1Arg,
in unsigned long parm2Arg,
in unsigned long parm3Arg);

An example of a STARTUP.HTM source code that uses the aforementioned APIs is as follows.

<?xml version= “1.0” encoding = “UTF-8”?>
<!DOCTYPE html PUBLIC-//DVD//DTD XHTML DVD-HTML 1.0//EN
“http://www.dvdforum.org/enav/dtd/dvdhtml-1-0.dtd”>
<html>
<head>
<title>Trigger Event Sample </title>
<style type = “text/css”>
<!−− start screen construction after subtracting 10% from each edge of a screen having a
general 4 × 3 aspect ratio and determining the logical pixels of an OSD screen to be
720 × 480, with a video display method as a background −−>
@video-display {
video-placement: background
video-aspect-ratio:4 × 3N
video-clip-rectangle: (0,0,720,480)
video-background-color: #00000000
clip-rectangle : (0,0,720,480)
viewport-rectangle : (0,0,720,480)
</−− the background color of the body is determined to be transparent −−>
body {background-color : transparent }
#quiz {

position:absolute; visibility;hidden; overflow:hidden;
width:277; height:98; clip:rect (0 277 98 0);
background-color:#eeeeee;
border:outset 4px;

</style>
<script>
<!−−
function dvdvideo_handler(evt)
/* evt follows the interface standard of the aforementioned Dvd Event Ojbect. */
{

switch (evt. index)
{
case TRIGGER_EVENT:// trigger event is trapped.

If (evt.parm1 == 1 && evt.parm2 == 0)
{/* trigger event 1 designated below is received. */

var demo = document.getElementById(‘quiz’)
demo.style.left = 435; demo.style.top = 377;

demo.style.visibility = visible ;
DvdVideo.ClearTrigger(1);
}
if (evt.parm1 == 2 && evt.parm2 == 0)
{/* trigger event 2 designated below is received and preloaded. */
navigator.Preload (“dvd://dvd_enav/startup.pld”,
“text/preload”);

}

}
}
function setupEventListeners( )
{

var htmlNode = document.documentElement;
/* event handler is installed */
htmlNode.addEventListener(“dvdvideo”,dvdvideo_handler,true);
/* locations where trigger events 1 and 2 are to occur are determined */

DvdVideo.SetTrigger(1,1,1000,0); /* trigger where quiz is popped up */
DvdVideo.SetTrigger(2,1,1200,0); /* trigger where preloading is requested */
DvdVideo.Play( ); /* reproduction starts */
}
//!−−>
</script>
</head>
<body onload = “setupEventListeners( )”> <!—when body is loaded, setupEventListeners are
called. */
<div id = “quiz”><img src=“quiz.png”></div>
</body>
</html>

An example of a source code of a preloading list file STARTUP.PLD will now be illustrated.

<?xml version= “1.0” encoding=“UTF=8” ?>
<!DOCTYPE preload PUBLIC”-\ \ DVD\ \ DTD DVD Preload List 1.0\ \ EN”
“http://www.dvdforum.org/enav/dvd-preload-list.dtd” −−>
<preload cachesize=”128KB”>
<filedef type=”text/xml” href= “dvd://DVD_ENAV/A.HTM”/>
<filedef type=”image/png” href= “dvd://DVD_ENAV/A.PNG”/>
</preload>

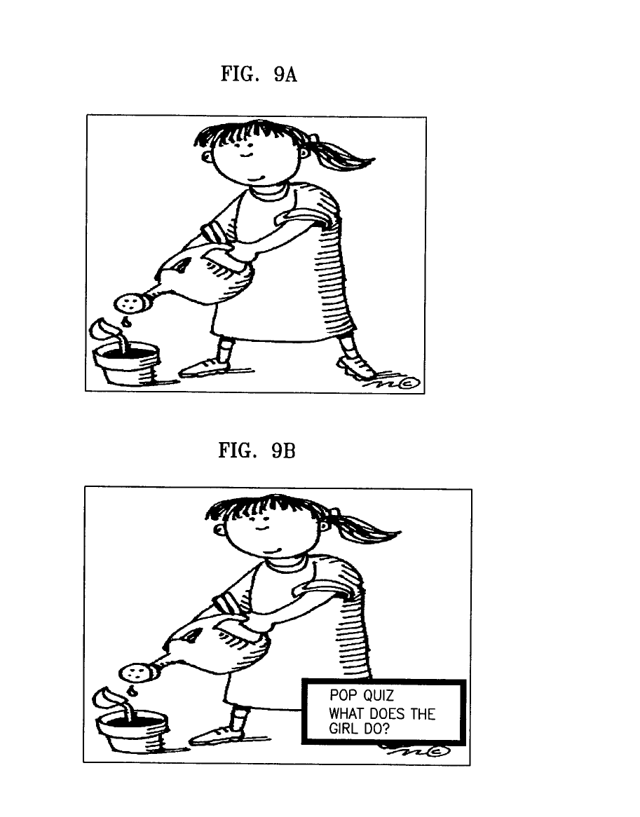

FIGS. 9A and 9B are screens on which the trigger event occurs according to the above-described source codes. Referring to FIGS. 9A and 9B, no events occur when the NV_PCK_LBN is 0, and a quiz screen (markup document screen) from a quiz file QUIZ.PNG is output on the AV screen at the point in time VOBU_S_PTM when an indicated event occurs, for example, when the NV_PCK_LBN is 1000.

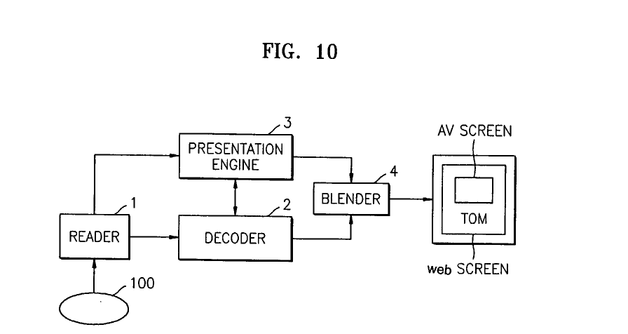

FIG. 10 is a block diagram of a reproduction apparatus according to another embodiment of the present invention. Referring to FIG. 10, the reproduction apparatus reproduces AV data from a disc 100. The AV data in the disc 100 includes at least one video object having video object units each having an audio pack, a video pack, and a navigation pack. The disc 100 stores event occurrence information for generating a designated event based on a data structure of the AV data. To perform reproduction, the reproduction apparatus includes a reader 1, a decoder 2, a presentation engine 3, and a blender 4. The reader 1 reads the AV data or the event occurrence information. The presentation engine 3 interprets the read-out event occurrence information, outputs an interpretation result to the decoder 2, and presents an event requested to occur by the decoder 2. To be more specific, first, the presentation engine 3 interprets the event occurrence information recorded in a reproduced markup document that defines a display window for displaying an AV screen in which the AV data has been reproduced. Then, the presentation engine 3 transmits the interpretation result, that is, information relating to the data structure on which an event occurrence request is based, to the decoder 2. For example, information relating to a point in time (place) VOBU_S_PTM when an event occurrence is requested can be expressed based on a designated navigation pack in a predetermined video title set.

In an aspect of the present invention, for example, the event occurs based on a video title set number (VTSN) and a navigation pack number (NV-PCK_LBN). However, in another aspect of the present invention, the event can occur based on other data conditions, such as a video object number VOB_ID, a start point in time of a video object unit VOBU_S_PTM, or the like.

For example, the event can occur based on the number of a program chain and an elapsed time C_ELTM for reproducing the program chain. The decoder 2 checks the data structure while decoding the read-out AV data. If the decoder 2 discovers data satisfying a condition in which the event occurrence is requested, the decoder 2 notifies the presentation engine 3 of the discovery of the data. When the presentation engine 3 reproduces the AV data having the discovered data structure, it outputs designated contents on a screen, for example, at the point in time VOBU_S_PTM or several tens of milliseconds after the start of reproduction of a VOBU corresponding to a designated navigation pack NV-PCK in a designated video title set VTS. Also, as another example, the presentation engine 3 outputs the designated contents on the screen at a designated elapsed time C_ELTM for a designated program chain or several tens of milliseconds after the elapsed time C_ELTM.

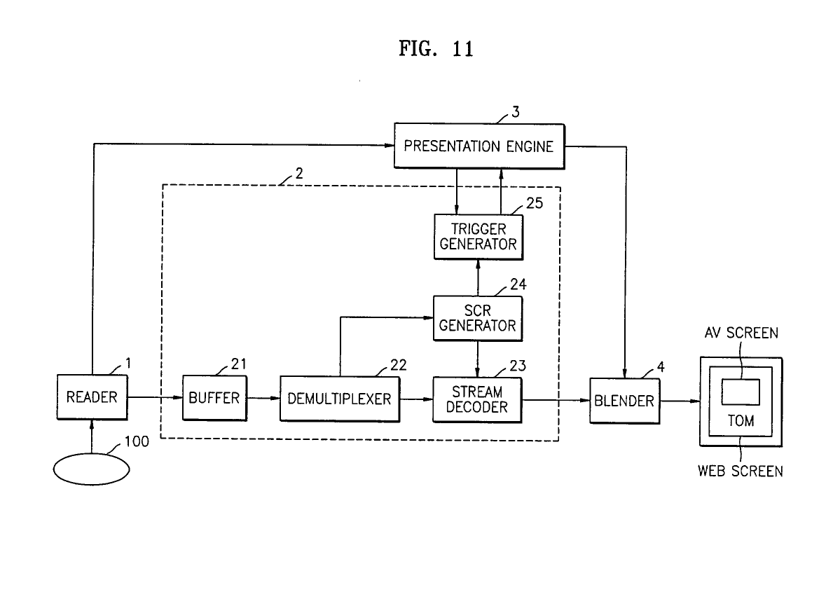

FIG. 11 is a block diagram of the decoder of the reproduction apparatus shown in FIG. 10. The same blocks as those of FIG. 10 will not be described in detail because they perform the same functions.

Referring to FIG. 11, the decoder 2 includes a buffer 21, a demultiplexer 22, a stream decoder 23, a system clock reference (SCR) generator 24, and a trigger generator 25. The buffer 21 receives, as the AV data, an MPEG PS stream according to this embodiment of the present invention, and buffers the same. The demultiplexer 22 demultiplexes the MPEG PS stream to packets. The SCR generator 24 monitors clock information attached to each of the packets in order to generate a system clock reference based on a predetermined clock value of the packets. The trigger generator 25 receives the event occurrence information from the presentation engine 3 and notifies the presentation engine 3 of the point in time VOBU_S_PTM when a trigger occurs in a SCR signal corresponding to the received event occurrence information. Meanwhile, the stream decoder 23 decodes the stream packets based on the SCR signal.

FIG. 12 is a reference diagram for illustrating in greater detail a process of generating an event in the reproduction apparatuses of FIGS. 10 and 11. Referring to FIG. 12, a display screen includes a screen for a markup document and an AV screen inserted into (disposed in) the markup document screen. The presentation engine 3 sets a trigger position for a trigger event and transmits the set trigger position to the decoder 2. In other words, the presentation engine 3 interprets an API in the markup document and transmits a value of a parameter of which the trigger event is set up to the decoder 2. The decoder 2 detects a navigation pack in a video title set matched with the parameter value and transmits a trigger identifier to the presentation engine 3 in order to notify the presentation engine 3 to generate a specified event. Accordingly, the presentation engine 3 calls an in-built event handler. The event handler generates the event for displaying appropriate contents on the screen, at a point in time when the generation of the event is request or several milliseconds after the point in time.

Furthermore, the presentation engine 3 can generate the event to preload a corresponding file, at the point in time when the generation of the event is requested or several milliseconds after the point in time.

A reproduction method according to the present invention performed in a reproduction apparatus having such a structure as described above will now be described.

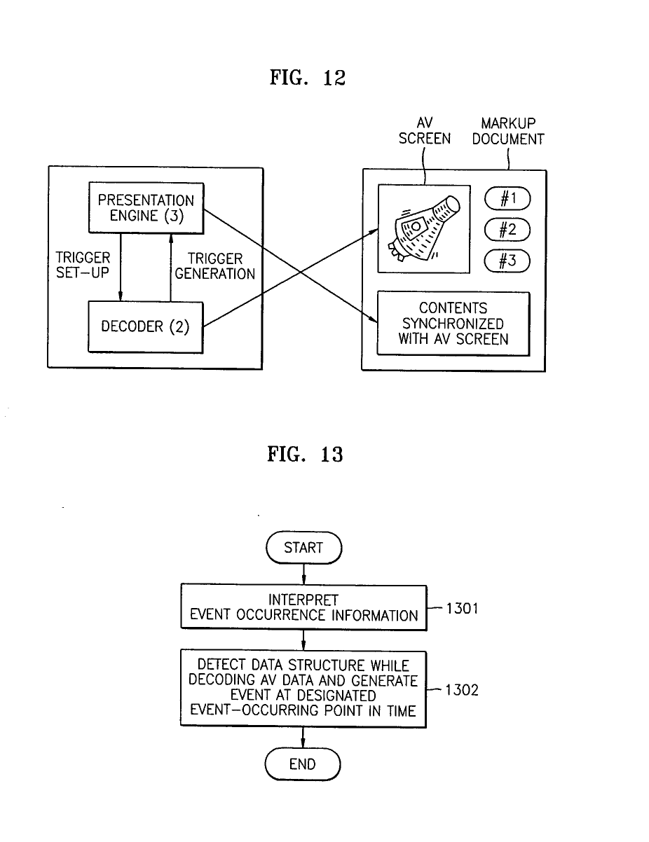

FIG. 13 is a flowchart illustrating the reproduction method in the reproduction apparatus shown in FIGS. 10 and 11. Referring to FIG. 13, first, the reproduction apparatus interprets the event occurrence information recorded on the disc 100 in operation 1301. Next, the reproduction apparatus detects the data structure of the AV data while decoding the AV data and generates the event at a designated place defined in the data structure in operation 1302.

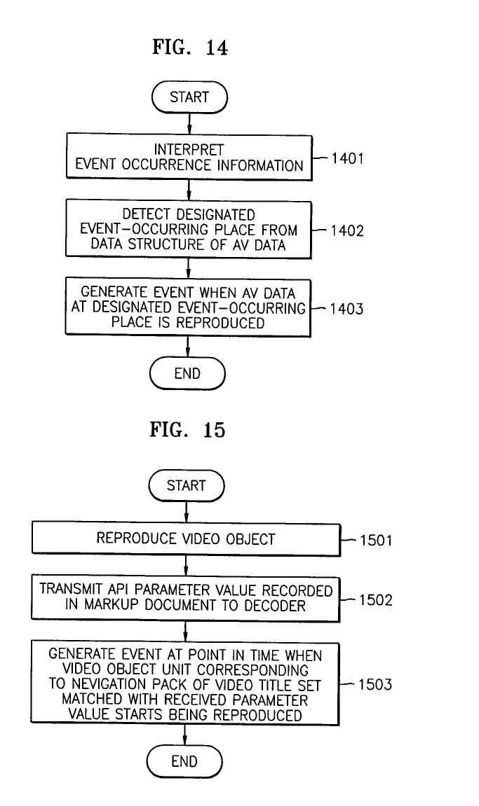

FIG. 14 is a flowchart illustrating another reproduction method in the reproduction apparatus shown in FIGS. 10 and 11. Referring to FIG. 14, the reproduction apparatus reproduces a video object requested by a user and outputs the video data on the AV screen. Meanwhile, the reproduction apparatus also overlaps the output AV screen on the display window for the markup document. At this time, in operation 1401, the reproduction apparatus interprets the event occurrence information recorded in the markup document. Next, in operation 1402, the reproduction apparatus detects a designated place where the event occurs from the interpreted data structure. Thereafter, the reproduction apparatus generates the corresponding event when the AV data at the detected place where the event occurs is reproduced, in operation 1403.

FIG. 15 is a flowchart illustrating another reproduction method in the reproduction apparatus shown in FIGS. 10 and 11. Referring to FIG. 15, in operation 1501, the decoder 2 of the reproduction apparatus reproduces the video object that the user requests. Meanwhile, in operation 1502, the presentation engine 3 interprets an API recorded in the corresponding markup document and transmits a corresponding parameter value to the decoder 2. When a video object unit that contains a designated navigation pack NV_PCK in a video title set VTS matched with the received parameter value is detected, or a program chain number and an elapse time are detected, the decoder 2 notifies the presentation engine 3 of the detection. The presentation engine 3 calls (controls) the event handler to output designated contents on the screen at the point in time when or several tens of milliseconds after a corresponding video object unit starts being reproduced. Alternatively, in operation 1503, the presentation engine 3 outputs designated contents on the screen at the elapse time to reproduce a corresponding program chain or several tens of milliseconds after the elapse time. If the corresponding event has been preloaded, a corresponding preloading list file is preloaded.

In the above embodiments, the event occurs based on a corresponding video title set number (VTSN) and a corresponding navigation pack number NV_PCK_LBN. However, the event can occur based on other types of data structure, such as a video object number VOB_ID, a VOBU-reproduction start point in time VOBU_S_PTM, or the like.

The reproduction method can be written as a computer program. Codes and code segments for a computer program can be easily inferred by a computer programmer skilled in the art. Also, the program is stored in a computer readable recording medium and is read and executed by a computer in order to achieve a method of recording and reproducing a markup document and AV data. Examples of the computer readable recording medium include magnetic recording media, optical data storage devices, and carrier wave media.

While the present invention has been particularly shown and described with reference to preferred embodiments thereof, it will be understood by those of ordinary skill in the art that various changes in form and details may be made therein without departing from the spirit and scope of the present invention as defined by the following claims and their equivalents. Hence, disclosed embodiments must be considered not restrictive but explanatory. The scope of the present invention is not presented in the above description but in the following claims, and all differences existing within the equivalent scope to the scope of the present invention must be interpreted as being included in the present invention.

As described above, in the present invention, an event-occurrence point in time is more simply designated by utilizing the data structure of an existing DVD-Video without change, and a specified event occurs at the designated event-occurrence point in time. Accordingly, a markup document screen can be more easily output in synchronization with an AV screen. That is, since a software timer does not need to operate to output the markup document screen in synchronization with the AV screen, the markup document screen can be more simply output. In addition, preloading is performed at a designated point in time.

What is claimed is:

1. An information storage medium comprising:
AV data including at least one video object that is constituted of video object units each having an audio pack, a video pack, and a navigation pack; and
event occurrence information for generating an event designated based on a data structure of the AV data.

2. The information storage medium of claim 1, further comprising:
a markup document for outputting an AV screen corresponding to the AV data, wherein the event occurrence information is recorded in the markup document.

3. The information storage medium of claim 1, wherein the AV data comprises a video title set, a video object constituting the video title set, and the video object units constituting the video object and including the audio pack, the video pack, and the navigation pack, and the event occurrence information is for requesting that a trigger event occurs when one of the video object units corresponding to the navigation pack of the video title set is reproduced.

4. The information storage medium of claim 3, wherein the event occurrence information requests that designated contents are output on a screen when one of the video object units corresponding to the navigation pack of the video title set is reproduced.

5. The information storage medium of claim 4, further comprising
markup document data including the event occurrence information to output a markup screen, wherein the designated contents are displayed on a predetermined portion of the markup screen on which a markup document is reproduced.

6. The information storage medium of claim 4, wherein the event occurrence information comprises:
a trigger event identifier;
a video title set identifier of a designated video title set; and
a navigation pack identifier of a designated navigation pack.

7. The information storage medium of claim 6, wherein the trigger event identifier comprises:
an application program interface for setting the trigger event and canceling the trigger event.

8. The information storage medium of claim 7, wherein the application program interface comprises:
parameters including the trigger event identifier, the video title set identifier of the designated video title set, and the navigation identifier of the designated navigation pack.

9. The information storage medium of claim 6, wherein the video title set identifier comprises a video title set number, and the navigation pack identifier comprises:
a navigation pack number.

10. The information storage medium of claim 6, wherein the video title set identifier comprises a video object number of the video title set to which a currently reproduced title belongs, and the navigation pack identifier is determined by a point in time at which reproduction of one of the video object units starts.

11. The information storage medium of claim 6, wherein the video title set identifier comprises a program chain number, and the navigation identifier comprises:
one of a time and a place of reproduction of a program chain displayed on the screen using a cell elapse time.

12. The information storage medium of claim 6, wherein the video title set identifier comprises a title number, and the navigation pack identifier comprises:
one of a time and a place of reproduction of the video title set.

13. A method of playing an information storage medium comprising AV data, which includes a video title set containing at least one video object containing video object units each having an audio pack, a video pack, and a navigation pack, and event occurrence information for generating a predetermined event, the method comprising:
interpreting the event occurrence information; and
generating the event if a data structure matched with a result of the interpretation of the event occurrence information is discovered while the AV data is being decoded.

14. The method of claim 13, wherein the an information storage medium comprises a markup document containing the event occurrence information, and the interpreting of the event occurrence information comprises:
reading event occurrence information from the markup document in which a display window for displaying an AV screen on which the video object is reproduced is defined; and
detecting place in which the event matched with the interpretation result occurs.

15. The method of claim 14, wherein the video object that is constituted of cells each having the audio pack, the video pack, and the navigation pack, and the generating of the event comprises:
reproducing a portion of the AV data corresponding to the place in which the event occurs.

16. The method of claim 15, wherein the generating of the event comprises:
outputting designated contents on a screen at a point in time or several milliseconds after the reproduction of the portion of the video object unit corresponding to the navigation pack of the video title set.

17. The method of claim 13, wherein the event occurrence information comprises:
a trigger event identifier;
a designated video title set identifier; and
a designated navigation pack identifier.

18. The method of claim 17, wherein the trigger event identifier comprises:
a first identifier for setting a trigger event; and
a second identifier for canceling the trigger event.

19. The method of claim 13, wherein the event occurrence information is implemented as an application program interface.

20. The method of claim 19, wherein the application program interface comprises:
parameters including the trigger event identifier, the video title set identifier of a designated video title set, and the navigation pack identifier of a designated navigation pack.

21. An apparatus for playing an information storage medium comprising AV data, which includes a video title set containing at least one video object that is constituted of video object units each having an audio pack, a video pack, and a navigation pack, and event occurrence information for generating a predetermined event, the apparatus comprising:
a reader reading the AV data or the event occurrence information;
a presentation engine interpreting the read event occurrence information, outputting the interpretation result, and generating the event; and
a decoder requesting the presentation engine to generate an appropriate event if a data structure of the AV data matched with the interpretation result received from the presentation engine is discovered during decoding the AV data.

22. The apparatus claim 21, wherein the information storage medium comprises markup document data containing the event occurrence information, and the presentation engine interprets the event occurrence information read from the markup document defining a display window for displaying an AV screen on which the AV data is reproduced.

23. The apparatus of claim 22, wherein the presentation engine generates the event when the AV data corresponding to the navigation pack of a designated video title set is reproduced.

24. The apparatus of claim 23, wherein the presentation engine provides a screen in accordance with the markup document data and outputs designated contents on the screen at a point in time when or several tens of milliseconds after a video object unit corresponding to the navigation pack of the designated video title set starts being reproduced.

25. The apparatus of claim 24, wherein the event occurrence information is implemented as an application program interface.

26. The apparatus of claim 25, wherein the application program interface comprises:
parameters including a trigger event identifier, a video title set identifier of the designated video title set, and a navigation pack identifier of the designated navigation pack.

27. The apparatus of claim 26, wherein the trigger event identifier comprises:
a first identifier for setting the event; and
a second identifier for canceling the event.

28. An information storage medium comprising:
AV data having a data structure, which includes a video title set containing a video object having a plurality of video object units each having an audio pack, a video pack, and a navigation pack; and
markup document data containing event occurrence information generating a designated event based on the data structure of the AV data.

29. The information storage medium of claim 28, wherein the event occurrence information comprises:
event information; and
a request displaying a content of the AV data on a designated portion of a screen provided by the markup document when the data structure of the AV data is matched with the event information.

30. A method of reproducing data from an information storage medium comprising AV data, which comprises a data structure including a video title set containing a video object having a plurality of video object units each having an audio pack, a video pack, and a navigation pack, and markup document data comprising event occurrence information, the method comprising:
reading the markup document data;
interpreting the event occurrence information;
generating a screen provided by the markup document data; and
displaying a content of the AV data on a portion of the screen according to an event of event occurrence information when the data structure of the AV data is matched with the event occurrence information.

31. The method of claim 30, wherein the markup document data comprises parameters including a trigger event identifier, a video title set identifier of a designated video title set, and a navigation pack identifier of a designated navigation pack, and generating of the content comprises:
matching the parameters of the markup document data with the navigation pack of the video title set.
